(19) United States
(12) Patent Application Publication
(10) Pub. No.: US 2026/0281114 A1
(43) Pub. Date: Sep. 17, 2026

(54) DYNAMIC CORE GATEWAY ASSIGNMENT AND CONFIGURATION

(71) Applicant: Charter Communications Operating, LLC, St. Louis, MO (US)

(72) Inventor: Timothy Clark Bleidorn-Piper, Colorado Springs, CO (US)

(21) Appl. No.: 19/078,550

(22) Filed: Mar. 13, 2025

(51) Int. Cl. H04L 9/40; H04L 12/46; H04W 12/06

(52) U.S. Cl. CPC H04L 63/0892; H04L 12/4633; H04W 12/06

(57) ABSTRACT

A computing system receives an access-request message from a wireless access point (AP), which includes access identity information associated with the UE. The computing system obtains subscriber policy data associated with the UE based on the access identity information and selects the core gateway for the UE based on the subscriber policy data. The computing system provides routing instructions to the wireless AP, which cause the wireless AP to establish a layer 2 tunnel endpoint at the particular core gateway selected by the computing system.

### BACKGROUND

Devices connected to a local area network (LAN) typically communicate with other devices connected to the same LAN via layer 2 communication protocols, and with devices connected to another LAN via layer 3 protocols. Layer 3 protocol communications are facilitated via a gateway router that is typically physically connected to the same LAN as the sending device and also connected to another network. It can be desirable for a service provider to move functionality conventionally provided by the gateway router in a subscriber's home to the service provider's network for a variety of reasons, including, for example, to reduce a need to send a technician to a customer premises to diagnose and correct issues, facilitate faster problem resolution, and simplify introducing new features.

### SUMMARY

The examples disclosed herein implement dynamic core gateway (e.g., bridged network gateway (BNG), wireless access gateway (WAG), etc.) configuration operations to provide differentiated services to individual devices (e.g., user equipment (UE(s))) operating on a local area network (LAN).

In one implementation, a method is provided. The method includes receiving, by a computing system comprising one or more computing devices, an access-request message from a wireless access point (AP) coupled to a local area network (LAN), the access-request message comprising access identity information associated with a user equipment (UE) that is requesting to connect to the wireless AP. The method further includes obtaining, by the computing system, subscriber policy data associated with the UE based on the access identity information of the access-request message. The method further includes selecting, by the computing system, a first core gateway of a plurality of different core gateways implemented by the computing system based on the subscriber policy data associated with the UE. The method further includes sending, by the computing system to the wireless AP, routing instructions comprising a first core gateway identifier to facilitate use of the first core gateway by the UE.

In another implementation, a computing system is provided. The computing system includes one or more computing devices. The one or more computing devices are operable to receive an access-request message from a wireless access point (AP) coupled to a local area network (LAN), the access-request message comprising access identity information associated with a user equipment (UE) that is requesting to connect to the wireless AP. The one or more computing devices are further operable to obtain subscriber policy data associated with the UE based on the access identity information of the access-request message. The one or more computing devices are further operable to select a first core gateway of a plurality of different core gateways implemented by the computing system based on the subscriber policy data associated with the UE. The one or more computing devices are further operable to send, to the wireless AP, routing instructions comprising a first core gateway identifier to facilitate use of the first core gateway by the UE.

In another implementation, a method is provided. The method includes receiving, by a wireless access point (AP) coupled to a local area network (LAN), a first connection request from a first user equipment (UE) attempting to connect to the wireless AP. The method further includes sending, by the wireless AP to a computing system implementing a service provider network, a first access-request message associated with the first UE. The method further includes receiving, by the wireless AP from the computing system, a first access-accept message comprising routing instructions for the first UE. The method further includes establishing, by the wireless AP, a first layer 2 tunnel with a first core gateway of a plurality of different core gateways implemented by the computing system based on the routing instructions for the first UE.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for implementing a dynamic core gateway(s) configuration framework according to some implementations;

FIGS. 2A-2C are illustrative examples of the dynamic core gateway configuration operations according to some implementations;

FIGS. 3A-3B are sequence diagrams illustrating messages communicated between and actions taken by certain components illustrated in FIG. 1 to perform dynamic core gateway configuration operations according to some implementations;

FIG. 4 is a flowchart of an example method for implementing dynamic core gateway configuration operations according to some implementations;

FIG. 5 is a flowchart of an example method for implementing dynamic core gateway configuration operations according to some implementations;

FIG. 6 is a block diagram of an example core gateway of a computing system suitable for implementing examples disclosed herein according to some implementations; and

FIG. 7 is a block diagram of an example customer premises equipment (CPE) suitable for implementing examples disclosed herein according to some implementations.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Devices connected to a local area network (LAN) typically communicate with other devices connected to the same LAN via layer 2 communication protocols, and with devices connected to another LAN via layer 3 communication protocols. Layer 3 protocol communications are facilitated via a gateway router that is typically physically connected to the same LAN and also connected to another network, such as a network of a service provider that provides broadband access to the entity operating the LAN. The gateway router implements traditional gateway router services, such as dynamic host configuration protocol (DHCP) services for providing network-connected computing devices with internet protocol (IP) addresses as needed, network address translation (NAT) services to translate private IP addresses associated with a subnetwork to a public IP address, Domain Name System (DNS) services for translating a domain name to an IP address, and the like.

A service provider may desire to provide gateway router functionality from a location within the service provider's network rather than from the customer premises. Moving the gateway functionality from the subscriber's physical location to a network gateway router at a service provider's location, sometimes referred to as a “virtual gateway” or a “virtual gateway router” (VGR), may make it easier to support customer issues and reduce the need to send a technician to a customer premises such as a home or business. It should be understood that, as used herein, the term “customer(s)” or “subscriber(s)” or “user(s)” may be used interchangeably.

The terms subnetwork, or subnet, will be treated synonymously herein, and refer to a data communications network, often but not necessarily an Ethernet network, wherein each connected computing device on the subnet has an IP address that has the same network address, and which utilizes the same subnet mask to determine whether other computing devices are on the same network or are on a different network. Such computing devices may be referred to herein as being “on” or “connected to” or “coupled to” the same subnet. Computing devices on the same subnet can communicate with one another, typically via layer 2 addressing, such as a media access control (MAC) address, without the need for a router. A LAN is an example of a subnet.

Since a virtual gateway is not physically directly connected to the LAN in the same manner as a conventional gateway router, to implement a virtual gateway in a manner that is transparent to devices connected to the LAN, a device on the LAN, such as a wireless access point (AP) (e.g., bridged gateway), may establish a logical subscriber link (LSL) between the wireless AP and the virtual gateway. The LSL is typically implemented as a layer 2 (over layer 3) tunnel between the wireless AP and the virtual gateway, such as, by way of non-limiting example, a GRE tunnel. The wireless AP may send layer 2 frames generated by devices on the LAN to the virtual gateway via the tunnel and may receive layer 2 frames generated by the virtual gateway via the tunnel and send the layer 2 frames to a device or devices on the LAN. This is done transparently such that devices on the LAN are unaware that the virtual gateway is not actually directly connected to the same physical network as the devices on the LAN.

Multiple virtual gateways (hereinafter, VG(s) and/or VGR(s)) may be implemented on a single computing device, such as a core gateway. Service provider networks may include a plurality of different core gateways. Each core gateway may be a remote computing device that is configured to implement a plurality of VGRs that provide default gateway functionality and/or functions for a LAN, such as NAT service(s), DHCP service(s), DNS service(s), and/or a router function to facilitate communication between a computing device connected to a corresponding LAN and a computing device connected to another network. Each core gateway may be any suitable computing device operable to initiate a plurality of VGRs such as, by way of non-limiting example, a bridged network gateway (BNG), a wireless access gateway (WAG), and/or the like.

A core gateway instantiates a VGR upon the occurrence of some event, such as the receipt of traffic by the core gateway from the wireless AP. The core gateway configures the VGR with appropriate subscriber context, such as the class of service, parental controls set up by the network subscriber, the service tier (e.g., purchased bandwidth limits), preferential treatment for certain computing devices that may connect to the LAN, and/or the like.

Residences and business enterprises, generally referred to as subscribers, may obtain public networking capabilities, such as an ability to access the Internet, from a service provider. In some instances, a service provider may offer various networking packages, sometimes referred to as “service tier(s),” for different fees. By way of non-limiting example, a first service tier may include a first amount of bandwidth (e.g., a download bandwidth of 1 gigabits per second (Gbps)), may be priced at a greater monthly fee than a second service tier that includes a lower amount of bandwidth (e.g., a download bandwidth of 500 megabits per second (Mbps)). However, some core gateways provide default gateway services for each computing device operating on the LAN, thereby preventing a service provider from providing differentiated network services (e.g., different network services associated with different service tiers) to different computing devices operating on the same LAN.

Accordingly, example aspects of the present disclosure are directed to a dynamic core gateway configuration framework, thereby allowing for differentiated network services to be provided to individual devices (e.g., user equipment (UE(s))) operating on a LAN. More particularly, a wireless AP coupled to the LAN may receive a connection request from a first UE attempting to connect to the wireless AP. The wireless AP may generate and send a first access-request message to a computing system implementing a service provider network. The first access-request message may be associated with the first UE and may include access identity information associated with the first UE, such as network credentials associated with the first UE and/or a first network subscriber associated with the first UE, a Media Access Control (MAC) address associated with the first UE, and/or the like.

The computing system may receive the first access-request message from the wireless AP and may obtain subscriber policy data associated with the first UE based on the access identity information of the first access-request message. As discussed in greater detail below, the computing system may select a first core gateway of a plurality of different core gateways implemented by the computing system based on the subscriber policy data associated with the first UE. The computing system may generate and send a first access-accept message to the wireless AP, which includes routing instructions associated with the first core gateway. The routing instructions may include a first core gateway identifier (e.g., Internet Protocol (IP) address associated with the first core gateway, a Uniform Resource Locator (URL) address associated with the first core gateway, etc.) to facilitate use of the first core gateway by the first UE.

The wireless AP may receive the first access-accept message from the computing system and may establish a first layer 2 tunnel with the first core gateway based on the routing instructions. Thereafter, the wireless AP may receive messages from the first UE, encapsulate the messages into a layer 3 protocol, and send the messages to the first core gateway via the first layer 2 tunnel. Likewise, the wireless AP may receive messages from the first core gateway via the layer 2 tunnel, determine that the first UE is the intended recipient of the messages, and may provide the messages to the first UE.

In some examples, concurrently with and/or consecutively to the first connection request, the wireless AP may receive a second connection request from a second UE attempting to connect to the wireless AP that is different from the first UE (e.g., associated with a different network subscriber relative to the first UE). In such examples, the wireless AP may generate and send a second access-request message to the computing system. The second access-request message may be associated with the second UE and may include access identity information associated with the second UE, such as network credentials associated with the second UE and/or a second network subscriber associated with the second UE, a Media Access Control (MAC) address associated with the second UE, and/or the like.

The computing system may receive the second access-request message from the wireless AP and may obtain subscriber policy data associated with the second UE based on the access identity information of the second access-request message. As discussed in greater detail below, the computing system may select a second core gateway of the plurality of different core gateways implemented by the computing system based on the subscriber policy data associated with the second UE. In some examples, the second core gateway is a different core gateway relative to the first core gateway. The computing system may generate and send a second access-accept message to the wireless AP, which includes routing instructions associated with the second core gateway. The routing instructions may include a second core gateway identifier (e.g., Internet Protocol (IP) address associated with the second core gateway, a Uniform Resource Locator (URL) address associated with the second core gateway, etc.) to facilitate use of the second core gateway by the second UE.

The wireless AP may receive the second access-accept message from the computing system and may establish a second layer 2 tunnel with the second core gateway based on the routing instructions. Thereafter, the wireless AP may receive messages from the second UE, encapsulate the messages into a layer 3 protocol, and send the messages to the second core gateway via the first layer 2 tunnel. Likewise, the wireless AP may receive messages from the second core gateway via the layer 2 tunnel, determine that the second UE is the intended recipient of the messages, and may provide the messages to the second UE. In this manner, example aspects of the present disclosure provide a framework for dynamic, device-based core gateway configuration to provide differentiated services to computing devices operating on the same LAN.

The present disclosure provides a number of technical effects and benefits, including improvements to computing technology. Example aspects of the present disclosure provide a dynamic core gateway configuration and/or assignment framework, thereby enabling wireless APs to establish layer 2 (over layer 3) tunnels with multiple different core gateways of a service provider network. In this way, implementations of the present disclosure allow service provider(s) to provide differentiated network services to individual computing devices operating on the same LAN despite being coupled to the same wireless AP. That is, implementations of the present disclosure provide network subscribers (e.g., users) with the specific network services associated with their corresponding network subscription. As such, current network-service limitations typically associated with service provider networks may be obviated, such as providing the same network services to all devices operating on a LAN regardless of the network services associated with the device's network subscription. Furthermore, by generating and maintaining a subscriber database with data characterizing the network services associated with each network subscriber, a service provider is able to deploy core gateways that are configured to provide sufficient network services to the network subscribers in an efficient and targeted manner. In this way, operational costs associated with deploying and maintaining a plurality of different core gateways may be reduced, while simultaneously increasing the efficiency of network subscribers'use of the service provider's network resources.

Additionally, the present disclosure also provides a mechanism whereby a service provider may enter into a network partnership agreement (e.g., roaming agreement) with other service providers. For instance, suppose a UE is attempting to connect to a wireless AP associated with a first service provider, but the UE has a corresponding network subscription with a second service provider. By dynamically selecting and assigning core gateways based on the particular subscriber policy data associated with the UE, implementations of the present disclosure allow the first service provider to route the UE's traffic to a core gateway implemented by the second service provider's network, which conserves network resources for the first service provider while also ensuring that the network subscriber associated with the UE receives the network services associated with their particular network subscription.

Furthermore, example aspects of the present disclosure provide resulting improvements to computing technology. For instance, example aspects of the present disclosure provide a dynamic, efficient, and scalable framework for implementing core gateway assignment operations across service provider networks. Improvements in the efficiency of core gateway assignments may directly improve operational speeds for service provider networks and associated computing systems. By selecting core gateways based on the subscriber policy data and corresponding network services (e.g., service tier) associated with the UE, processing and storage requirements for the computing system implementing the service provider network may be directly reduced, ultimately resulting in more efficient resource use on both the system-side and the client-side. In this way, valuable computing resources that would otherwise be needed for default gateway functionality, VGR instantiation, gateway router functionality, etc., may be reserved for other tasks. Moreover, by assigning core gateways in a device-specific manner (e.g., based on the corresponding network subscriber), implementations of the present disclosure may obviate the inefficiencies associated with LAN-based core gateway assignments.

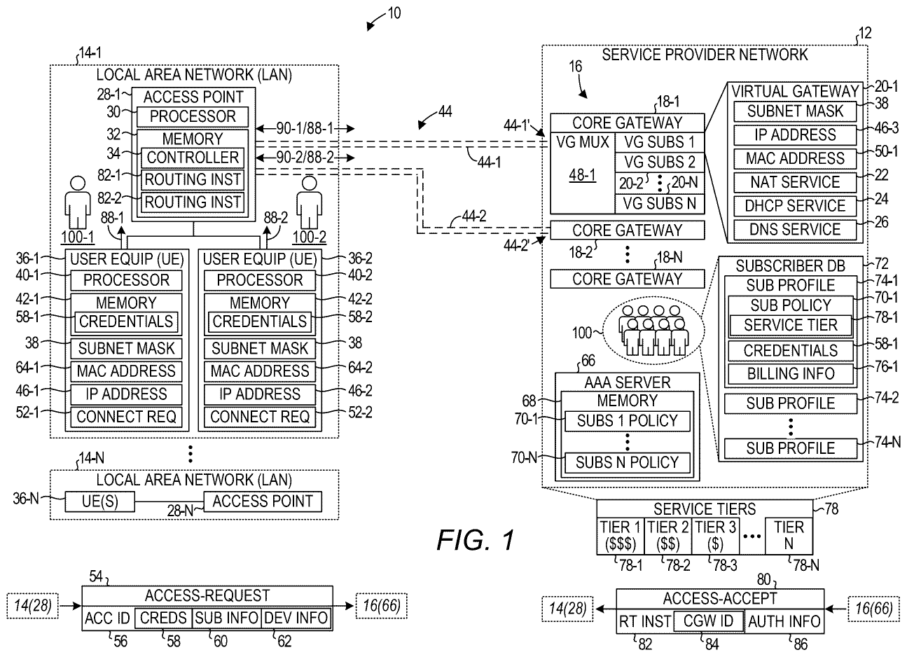

FIG. 1 depicts a block diagram of an environment 10 suitable for implementing a dynamic core gateway(s) configuration framework according to some implementations of the present disclosure. The environment 10 includes a service provider network 12 and a plurality of local area networks (LANs) 14-1 14-N (generally, LAN(s) 14) located in subscribers'premises, such as businesses, homes, and/or the like. The service provider network 12 is implemented by a computing system 16 that includes one or more computing devices (e.g., remote computing device(s)) that are remote (e.g., on another network) from the LANs 14. Together, the one or more computing devices of the computing system 16 form a service provider computing system/network (e.g., service provider network 12). It should be understood that example aspects of the present disclosure may be disclosed and/or depicted as being implemented by a single component on a single computing device of the computing system 16 for purposes of illustration and discussion. However, in some examples, the functionality described herein may be distributed across multiple components on multiple computing devices of the computing system 16. Moreover, while solely for purposes of illustration, various components will be illustrated as executing on the computing device(s) of the computing system 16, it is noted that the components could execute in different operating environments including, by way of non-limiting example, virtual machine environment(s), cloud computing environment(s), and/or the like.

More particularly, the computing system 16 includes a plurality of different core gateways 18-1-18-N (generally, core gateway(s) 18). Each core gateway 18 is a remote computing device that is configured to initiate a plurality of virtual gateways (VGRs) 20-1-20-N (generally, VGR(s) 20) that provide, for the LANs 14, default gateway router functionality and/or functions such as, by way of non-limiting example, a NAT service 22, a DHCP service 24, a DNS service 26, and a router function to facilitate communication between a computing device connected to a corresponding LAN 14 and a computing device connected to another network. It should be understood that “virtual gateway(s) (VG(s))” and “virtual gateway router(s) (VGR(s))” may be used interchangeably. It should be further understood that each core gateway 18 may be any suitable computing device operable to initiate a plurality of VGRs 20 such as, by way of non-limiting example, a bridged network gateway (BNG), a wireless access gateway (WAG), and/or the like. The core gateways 18 are physically located in a facility controlled by the respective service provider, and may be located tens, hundreds, or thousands of miles from the LANs 14. In some examples, the virtual gateways 20 may include a virtual gateway as described in TR-317 Network Enhanced Residential Gateway, available at www.broadband-forum.org/download/TR-317.pdf.

The LANs 14-1-14-N each include customer premises equipment (CPE), such as wireless access points (APs) 28-1-28-N (respectively) (generally, wireless AP 28). In some examples, the wireless APs 28-1-28-N are bridged gateways (BGs). It should be understood that the terms “wireless access point(s) (AP(s))” and “bridged gateway(s) (BG(s))” may be used interchangeably. The wireless AP 28-1 is coupled to the LAN 14-1 via a layer 2 LAN interface, such as an Ethernet wired transceiver, a Wi-Fi® transceiver, and/or both. The wireless AP 28-1 is a learning bridge and may serve as a Wi-Fi® access point and/or an Ethernet switch. As will be discussed in greater detail below, the wireless AP 28-1 also implements a transparent tunneling mechanism with one or more of the plurality of different core gateways 18.

The wireless AP 28-1 may include a processor device 30. The processor device 30 may include any computing or electronic device(s) capable of executing software instructions to implement the functionality described herein. For example, the processor device 30 may be one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The processor device 30 may be a single processor device and/or a plurality of processor devices that are operatively connected, for instance, in a parallel configuration.

The wireless AP 28-1 may further include a memory 32. The memory 32 may be communicatively coupled to the processor device 30. The memory 32 may include executable instructions that, when executed, cause the processor device 30 to perform operations, such as any of the operations described herein. In some examples, the memory 32 includes a controller 34 operable to implement the functionality described herein. Because the controller 34 is a component of the wireless AP 28-1, functionality implemented by the controller 34 may be attributed to the wireless AP 28-1 generally. Moreover, in examples where the controller 34 includes software instructions that program the processor device 30 to carry out the functionality described herein, functionality implemented by the controller 34 may be attributed to the processor device 30 and/or to the wireless AP 28-1 generally.

The memory 32 may be or otherwise include any device(s) capable of storing data, including, but not limited to, volatile memory (random access memory, etc.), non-volatile memory, storage device(s) (e.g., hard drive(s), solid state drive(s), etc.). For example, the memory device 32 may include one or more non-transitory computer-readable storage mediums, such as such as a Read Only Memory (ROM), Programmable Read Only Memory (PROM), Erasable Programmable Read Only Memory (EPROM), and flash memory, a USB drive, a volatile memory device such as a Random Access Memory (RAM), an internal or external hard disk drive (HDD), floppy disks, a blue-ray disk, or optical media such as CD ROM discs and DVDs, and combinations thereof. However, examples of the memory device 32 are not limited to the above description, and the memory device 32 may be realized by other various devices and structures as would be understood by those having ordinary skill in the art.

The wireless AP 28-1 may be communicatively coupled to one or more computing devices, such as user equipment (UEs) 36-1-36-2 (generally, UE(s) 36) via one or more networking technologies, such as Ethernet, Wi-Fi®, and/or the like. The UEs 36 may be any suitable computing device operable to access the service provider network 12. The wireless AP 28-1 and the UEs 36 are all on the same subnet (e.g., LAN 14-1), and thus each use a same subnet mask 38 to determine whether another computing device is on the LAN 14-1 or on a different network.

For instance, the UEs 36 may include a processor device 40. The processor device 40 may include any computing or electronic device(s) capable of executing software instructions to implement the functionality described herein. For example, the processor device 40 may be one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The processor device 40 may be a single processor device and/or a plurality of processor devices that are operatively connected, for instance, in a parallel configuration.

The UEs 36 may further include a memory 42. The memory 42 may be communicatively coupled to the processor device 40. The memory 42 may include executable instructions that, when executed, cause the processor device 40 to perform operations, such as any of the operations described herein. In some examples, the memory 42 includes a controller (not shown) operable to implement the functionality described herein. Because the controller (not shown) is a component of the UEs 36, functionality implemented by the controller may be attributed to the UEs 36 generally. Moreover, in examples where the controller (not shown) includes software instructions that program the processor device 40 to carry out the functionality described herein, functionality implemented by the controller (not shown) may be attributed to the processor device 40 and/or to the UEs 36 generally.

The memory 42 may be or otherwise include any device(s) capable of storing data, including, but not limited to, volatile memory (random access memory, etc.), non-volatile memory, storage device(s) (e.g., hard drive(s), solid state drive(s), etc.). For example, the memory device 42 may include one or more non-transitory computer-readable storage mediums, such as such as a Read Only Memory (ROM), Programmable Read Only Memory (PROM), Erasable Programmable Read Only Memory (EPROM), and flash memory, a USB drive, a volatile memory device such as a Random Access Memory (RAM), an internal or external hard disk drive (HDD), floppy disks, a blue-ray disk, or optical media such as CD ROM discs and DVDs, and combinations thereof. However, examples of the memory device 42 are not limited to the above description, and the memory device 42 may be realized by other various devices and structures as would be understood by those having ordinary skill in the art.

When serving as a Wi-Fi® access point, the wireless AP 28-1 may broadcast a service set identifier (SSID) to which the UEs 36 may, if properly authenticated, connect. The wireless AP 28-1 includes a wide area network (WAN) interface (not shown) via which the wireless AP 28-1 may communicate with computing devices on networks other than the LAN 14-1. The wireless AP 28-1 is configured with, and/or obtains during an initialization stage, an Internet Protocol (IP) address that is associated with the WAN interface (not shown). As described herein, the wireless AP 28-1 implements a transparent tunneling mechanism with one or more of the plurality of different core gateways 18-1-18-N via the WAN interface (not shown). The wireless AP 28-1 may initiate a controller, such as the controller 34, that implements some of the functionality described herein. The controller 34 is operable to generate and cause layer 2 frames to be transmitted via a layer 2 tunnel 44 for processing by a corresponding virtual gateway 20, and to generate and/or cause TCP/IP packets to be transmitted via the WAN interface (not shown) outside of the layer 2 tunnel 44 to computing devices, including one or more of the plurality of different core gateways 18.

During an initialization stage of the wireless AP 28-1, the wireless AP 28-1 establishes a layer 2 (via layer 3) tunnel 44 with one of the plurality of different core gateways 18, such as the core gateway 18-1. The tunneling protocol may include any suitable tunneling protocol; however, in some examples, the tunneling protocol includes a layer 2 tunneling protocol such as, by way of non-limiting example, the generic routing encapsulation (GRE) tunneling protocol. The wireless AP 28-1 and the core gateway 18-1 use their respective IP addresses to establish the layer 2 (over layer 3) tunnel 44. In some examples, the wireless AP 28-1 and the core gateway 18-1 may utilize encryption to encrypt the data sent over the layer 2 tunnel 44. Although not depicted in FIG. 1, there may be any number of devices between the wireless AP 28-1 and the core gateway 18-1, such as, by way of non-limiting example, a cable modem, one or more switching devices in the service provider network 12, a cable modem termination system (CMTS), and/or the like.

The core gateway 18-1 establishes a virtual gateway, such as the virtual gateway 20-1, that will initially serve as the default gateway router for the LAN 14-1. At connection time or during a power up, the UE 36-1 may broadcast a DHCP discover message in order to obtain an IP address 46-1. The wireless AP 28-1 sends the DHSP discover message to the core gateway 18-1 via the tunnel 44. A virtual gateway multiplexer 48-1 of the core gateway 18-1 determines that the message is destined for the virtual gateway 20-1 and provides the message to the virtual gateway 20-1 for processing. The virtual gateway 20-1 is provided a same subnet mask 38 as the subnet mask 38 provided to the UEs 36 on the LAN 14-1 and may be given an IP address 46-3 that is on the LAN 14-1. The virtual gateway 20-1 responds to the message using a layer 2 frame and sends the layer 2 frame toward the wireless AP 28-1. In the case where the message from the UE 36-1 is a DHCP Discover message, the layer 2 frame may include an IP address (e.g., IP address 46-1) for the UE 36-1, the subnet mask 38, and an indication that the virtual gateway 20-1 is the default gateway router for the LAN 14-1. The virtual gateway 20-1 inserts a MAC address 50-1 as the MAC address of the virtual gateway 20-1 in the layer 2 frame.

The core gateway 18-1 encapsulates the layer 2 frame into a layer 3 protocol, such as TCP/IP, and sends the layer 2 frame to the wireless AP 28-1 via the tunnel 44. The wireless AP 28-1 extracts the layer 2 frame from the layer 3 protocol and sends the layer 2 frame to the UE 36-1 using the same MAC address 50-1 of the virtual gateway 20-1 as the originator of the layer 2 frame. The UE 36-1 receives the response to the DHCP request and perceives the virtual gateway 20-1 as being physically on the LAN 14-1 because the tunnelling of packets between the wireless AP 28-1 and the core gateway 18-1 is transparent to any computing device (e.g., UE 36) connected to the LAN 14-1. Hence, the tunnel 44 is configured to provide layer 2 adjacency between the UE 36-1 and the core gateway 18-1.

Subsequently, if the UE 36-1 desires to send a packet to a computing device that is not on the LAN 14-1, the UE 36-1 will address the packet to the virtual gateway 20-1 using the MAC address 50-1. The wireless AP 28-1 will receive the packet, determine that the packet is addressed to the virtual gateway 20-1, encapsulate the packet in the layer 3 protocol, and send the packet to the core gateway 18-1 via the tunnel 44.

The virtual gateway multiplexer 48-1 will receive the packet, determine that the packet is destined for the virtual gateway 20-1, and send the packet to the virtual gateway 20-1. The virtual gateway 20-1 forwards the packet to a router based on routing tables maintained by the virtual gateway 20-1 in the same manner as a conventional gateway router.

The wireless AP 28-1 forwards all layer 2 frames generated by a computing device (e.g., UE 36) on the Lan 14-1 that have a destination address of the virtual gateway 20-1 and all broadcast layer 2 frames to the virtual gateway 20-1. To the UEs 36, the virtual gateway 20-1 appears to be directly coupled to the LAN 14-1.

The wireless APs 28-2-28-N and the core gateways 18-2-18-N operate in a substantially similar manner as described above with reference to the wireless AP 28-1 and the core gateway 18-1, respectively.

With this background, example aspects of the present disclosure are directed to systems, methods, frameworks, etc. for implementing dynamic selection and configuration of the core gateways 18 for computing devices, such as the UEs 36, on a per-device basis. That is, the computing system 16 may be configured to dynamically assign specific core gateways 18 and/or different core gateways 18 to individual UEs 36 operating on the same LAN 14 based on a variety of different device-specific criteria, thereby allowing the computing system 16 to provide differentiated network services to the UEs 36 even though the UEs 36 are operating on the same LAN 14.

More particularly, to initiate a connection sequence to the service provider network 12, a UE 36-1 provides a connection request 52-1 to the wireless AP 28-1. The wireless AP 28-1 may encapsulate and/or otherwise generate an access-request message 54-1 associated with the UE 36-1 based on the connection request 52-1. The access-request message 54-1 may include access identity information 56-1 associated with the UE 36-1. The access identity information 56-1 may include any suitable data identifying the UE 36-1, an identity of a network subscriber 100-1 associated with the UE 36-1, a network subscription of the network subscriber 100-1, and/or the like.

By way of non-limiting illustrative example, the access identity information 56-1 may include network credentials 58-1 identifying a particular network subscriber 100-1 associated with the UE 36-1 as an authorized user of the service provider network 12. The network credentials 58-1 may be provided to the wireless AP 28-1 by the UE 36-1, may be obtained by the wireless AP 28-1 from a memory device (e.g., the memory 32 and/or a remote memory device (not shown)), and/or any combination thereof.

In some examples, the access identity information 56-1 may include subscriber information 60-1 characterizing network features and/or other attributes associated with a particular subscription of the particular network subscriber 100-1 associated with the UE 36-1. The subscriber information 60-1 may be provided to the wireless AP 28-1 by the UE 36-1, may be obtained by the wireless AP 28-1 from a memory device (e.g., the memory 32 and/or a remote memory device (not shown)), and/or any combination thereof. In some examples, the access identity information 56-1 may include device information 62-1 characterizing a device identity, device features, and/or the like, associated with the UE 36-1. For instance, in some examples, the device information 62-1 may include a MAC address 64-1 associated with the UE 36-1. The device information 62-1 may be provided to the wireless AP 28-1 by the UE 36-1, may be obtained by the wireless AP 28-1 from a memory device (e.g., the memory 32 and/or a remote memory device (not shown)), and/or any combination thereof.

The wireless AP 28-1 may provide the access-request message 54-1 to the computing system 16 for authorization, approval, and/or the like. More particularly, the computing system 16 may include an Authentication, Authorization, and Accounting (AAA) server 66. The AAA server 66 may be configured to manage access to the service provider network 12 and/or its internal components. The AAA server 66 may be configured to implement any suitable AAA protocol such as, by way of non-limiting example, Remote Authentication Dial-In User Service (RADIUS), Terminal Access Controller Access-Control System Plus (TACACS+), Diameter, and/or the like.

The AAA server 66 may be and/or may include any suitable computing device, server computing device, and/or the like. For instance, the AAA server may include a processor device (not shown), such as any of the processor device(s) described herein. The AAA server 66 may further include a memory 68, such as any of the memory device(s) described herein. In some examples, the memory 68 may be a data cache operable to store data for a predetermined time period, such as 1 minute, 1 hour, 1 day, 1 week, etc.

Continuing with the example described above, the AAA server 66 may receive the access-request message 54-1 characterizing the request by the UE 36-1 to establish a communication link with the service provider network 12 via the wireless AP 28-1. The AAA server 66 may process the access-request message 54-1 to determine whether the UE 36-1 is authorized to access the service provider network 12.

In some examples, the AAA server 66 may determine whether the UE 36-1 is authorized to access the service provider network 12 based on the access identity information 56-1 (e.g., network credentials 58-1, subscriber information 60-1, device information 62-1) provided with the access-request message 54-1. In response to determining that the UE 36-1 is not authorized to access the service provider network 12, the AAA server 66 may generate and provide an access-denial message (not shown) to the wireless AP 28-1. In response to determining that the UE 36-1 is authorized to access the service provider network 12, the AAA server 66 may begin dynamic core gateway assignment operations and obtain subscriber policy data 70-1 associated with the UE 36-1 (e.g., based on the access identity information 56-1 of the access-request message 54-1).

More particularly, in response to determining that the UE 36-1 is authorized to access the service provider network 12, the AAA server 66 may determine an identity of the particular network subscriber 100-1 associated with the UE 36-1 based on the access identity information 56-1 (e.g., network credentials 58-1, subscriber information 60-1, device information 62-1). In some examples, the AAA server 66 may determine that the subscriber policy data 70-1 associated with the UE 36-1 is stored in the memory 68 (e.g., data cache) based on the identity of the particular network subscriber 100-1. In such examples, the AAA server 66 may obtain the subscriber policy data 70-1 associated with the UE 36-1 from the memory 68.

In some examples, the AAA server 66 may obtain the subscriber policy data 70-1 associated with the UE 36-1 from a remote computing device. More particularly, as shown, the computing system 16 may include a subscriber database 72. The subscriber database 72 may be configured to store and/or may otherwise include a plurality of subscriber profiles 74-1-74-N (generally, subscriber profiles 74) associated with a plurality of different network subscribers 100-1-100-N authorized to access the service provider network 12. Each subscriber profile 74-1-74-N may include subscriber policy data 70-1 70-N respectively associated with one of the plurality of different network subscribers 100-1-100N. Each subscriber profile 74-1-74-N may further include other data and/or information respectively associated with one of the plurality of different network subscribers 100-1-100N, such as, by way of non-limiting example, network credentials 58-1-58-N, billing information 76-1-76-N, device information 62-1-62-N, subscriber information 60-1-60-N, and/or any other suitable data characterizing the plurality of different network subscribers 100-1-100-N and/or their associated network subscription.

Continuing with the example described above, the AAA server 66 may query the subscriber database 72 based on the identity of the particular network subscriber 100-1 associated with the UE 36-1. For instance, the AAA server 66 may determine that a particular subscriber profile 74-1 in the subscriber database 72 is associated with the particular network subscriber 100-1. The AAA server 66 may obtain the subscriber policy data 70-1 of the particular subscriber profile 74-1 in the subscriber database 72 that is associated with the particular network subscriber 100-1 from the subscriber database 72. In some examples, subsequent to obtaining the subscriber policy data 70-1 of the particular subscriber profile 74-1 that is associated with the particular network subscriber 100-1, the AAA server 66 may store the subscriber policy data 70-1 in the memory 68 (e.g., data cache) for a predetermined time period (e.g., 1 minute, 1 hour, 1 day, 1 week, etc.).

The computing system 16 may then select one of the plurality of different core gateways 18 implemented by the computing system 16 based on the subscriber policy data 70 associated with the UE 36. More particularly, continuing the example described above, subsequent to obtaining the subscriber policy data 70-1 associated with the UE 36-1, the computing system 16 (e.g., the AAA server 66) may determine that the UE 36-1 is associated with a first service tier 78-1 of a plurality of different service tiers 78 based on the subscriber policy data 70-1.

As described herein, a service provider associated with the service provider network 12 may offer customers a plurality of different service tiers 78 that are each associated with different network services relative to one another such as, by way of non-limiting example, different latency queues, different bandwidth, different throughput, and/or the like.

As a non-limiting illustrative example, the first service tier 78-1 may be a premium service tier that is associated with premium network services, such as a download bandwidth of 1 Gbps. A second service tier 78-2 may be an intermediate service tier with intermediate network services, such as a download bandwidth of 500 Mbps. A third service tier 78-3 may be a standard service tier (e.g., entry-level service tier) with standard network services, such as a download bandwidth of 250 Mbps. In this example, the first service tier 78-1 may require a network subscription having a greater cost relative to the second service tier 78-2 and the third service tier 78-3, the second service tier 78-2 may require a network subscription having a greater cost relative to the third service tier 78-3 but a lower cost relative to the first service tier 78-1, and the third service tier 78-3 may require a network subscription having a lower cost relative to the first service tier 78-1 and the second service tier 78-2. That is, the first service tier 78-1 may be associated with a maximum network-service level relative to the service tiers 78-2-78-3, the second service tier 78-2 may be associated with lower network services relative to the first service tier 78-1 but greater network services relative to the third service tier 78-3, and the third service tier 78-3 may be associated with a minimum network-service level.

It should be understood that the above differentiation of the service tiers 78 is for purposes of illustration and discussion and is not intended to be limiting. Those having ordinary skill in the art, using the disclosures provided herein, will understand that the service tiers 78 may be differentiated based on any suitable network service, subscription model, cost structure, and/or the like, without deviating from the scope of the present disclosure.

The computing system 16 (e.g., AAA server 66) may determine that a first core gateway 18, such as the core gateway 18-1, is operable to provide the network services associated with the first service tier 78-1 and, in response, may select the core gateway 18-1 to provide default gateway functionality to the UE 36-1. More particularly, the AAA server 66 may determine that the core gateway 18-1 includes sufficient network resources (e.g., queues, memory, etc.) to provide the network services associated with the first service tier 78-1 and, as such, may determine that the core gateway 18-1 is suitable to provide default gateway functionality to the UE 36-1.

The computing system 16 may generate and send an access-accept message 80-1 to the wireless AP 28-1 that indicates the UE 36-1 is authorized to access the service provider network 12. As described herein, an access-accept message 80 may include routing instructions 82 that include an associated core gateway identifier 84, which identifies a particular core gateway 18 as a selected tunnel endpoint 44′ for a layer 2 tunnel 44. An access-accept message 80 may further include additional authorization information 86 that characterizes a variety of different authorization attributes for the corresponding UE 36, such as session authorization details (e.g., confirmation that the UE 36 is authenticated and authorized to operate on the service provider network 12, etc.), access control policies (e.g., bandwidth limits, Quality of Service (QoS) settings, etc.), reauthentication intervals, and/or any other suitable authorization attribute. More particularly, in some examples, in response to selecting the core gateway 18-1 of the plurality of different core gateways 18, the computing system 16 (e.g., AAA server 66) may generate routing instructions 82-1 configured to cause the wireless AP 28-1 to establish the layer 2 tunnel 44-1 (e.g., GRE tunnel) with the core gateway 18-1, thereby facilitating use of the core gateway 18-1 by the UE 36-1. The routing instructions 82-1 may include a first core gateway identifier 84-1 identifying the core gateway 18-1 as a tunnel endpoint 44-1′ for the layer 2 tunnel 44-1. By way of non-limiting illustrative example, the first core gateway identifier 84-1 may include an Internet Protocol address (e.g., IP address 46-3) associated with the core gateway 18-1, a Uniform Resource Locator (URL) address associated with the core gateway 18-1, and/or the like.

The wireless AP 28-1 may receive the access-accept message 80-1 from the computing system 16 and may establish the layer 2 tunnel 44-1 based on the routing instructions 82-1. Subsequently, the UE 36-1 may proceed with the initialization process with the service provider network 12 (e.g., via wireless AP 28-1) and, once completed, may begin exchanging data with and/or over the service provider network 12. For instance, the UE 36-1 may provide a message 88-1 to the wireless AP 28-1, which encapsulates the message 88-1 into a layer 3 protocol and provides the first message 88-1 to the core gateway 18-1 via the layer 2 tunnel 44-1 for transmission to entities operating on other networks. Likewise, the core gateway 18-1 may receive data 90-1 addressed to the UE 36-1 and may provide the data 90-1 to the UE 36-1 via the layer 2 tunnel 44-1.

Although described above in the context of dynamically assigning a core gateway 18 to a single computing device (e.g., UE 36-1) operating on the LAN 14-1, those having ordinary skill in the art, using the disclosures provided herein, will understand that the computing system 16 may dynamically assign core gateways 18 to any number of computing devices (e.g., UEs 36) operating on the LAN 14-1. In this way, the computing system 16 may be operable to provide differentiated network services (e.g., network services associated with the service tiers 78) to different UEs 36 (e.g., different network subscribers 100) operating on the LAN 14-1.

More particularly, concurrently with and/or consecutively to the first UE 36-1, a second UE 36-2 may initiate a connection sequence to the service provider network 12 by providing a second connection request 52-2 to the wireless AP 28-1. The wireless AP 28-1 may encapsulate and/or otherwise generate an access-request message 54-2 associated with the UE 36-2 based on the connection request 52-2. The access-request message 54-2 may be similar to the access-request message 54-1 described above. For instance, the access-request message 54-2 may include access identity information 56-2 associated with the UE 36-2. The access identity information 56-2 may include any suitable data identifying the UE 36-2, an identity of a network subscriber 100-2 associated with the UE 36-2, a network subscription of the network subscriber 100-2, and/or the like.

The access identity information 56-2 may be similar to the access identity information 56-1 described above. By way of non-limiting illustrative example, the access identity information 56-2 may include network credentials 58-2 identifying a particular network subscriber 100-2 associated with the UE 36-2 as an authorized user of the service provider network 12. The network credentials 58-2 may be provided to the wireless AP 28-1 by the UE 36-2, may be obtained by the wireless AP 28-1 from a memory device (e.g., the memory 32 and/or a remote memory device (not shown)), and/or any combination thereof.

In some examples, the access identity information 56-2 may include subscriber information 60-2 characterizing network features and/or other attributes associated with a particular subscription of the particular network subscriber 100-2 associated with the UE 36-2. The subscriber information 60-2 may be provided to the wireless AP 28-1 by the UE 36-2, may be obtained by the wireless AP 28-1 from a memory device (e.g., the memory 32 and/or a remote memory device (not shown)), and/or any combination thereof. In some examples, the access identity information 56-2 may include device information 62-2 characterizing a device identity, device features, and/or the like, associated with the UE 36-2. For instance, in some examples, the device information 62-2 may include a MAC address 64-2 associated with the UE 36-2. The device information 62-2 may be provided to the wireless AP 28-1 by the UE 36-2, may be obtained by the wireless AP 28-1 from a memory device (e.g., the memory 32 and/or a remote memory device (not shown)), and/or any combination thereof.

The wireless AP 28-1 may provide the access-request message 54-2 to the computing system 16 for authorization, approval, and/or the like. More particularly, the wireless AP 28-1 may provide the access-request message 54-2 to the AAA server 66. The AAA server 66 may receive the access-request message 54-2 characterizing the request by the UE 36-2 to establish a communication link with the service provider network 12 via the wireless AP 28-1. The AAA server 66 may process the access-request message 54-2 to determine whether the UE 36-2 is authorized to access the service provider network 12.

In some examples, the AAA server 66 may determine whether the UE 36-2 is authorized to access the service provider network 12 based on the access identity information 56-2 (e.g., network credentials 58-2, subscriber information 60-2, device information 62-2) provided with the access-request message 54-2. In response to determining that the UE 36-2 is not authorized to access the service provider network 12, the AAA server 66 may generate and provide an access-denial message (not shown) to the wireless AP 28-1. In response to determining that the UE 36-2 is authorized to access the service provider network 12, the AAA server 66 may begin dynamic core gateway assignment operations and obtain subscriber policy data 70-2 associated with the UE 36-2 (e.g., based on the access identity information 56-2 of the access-request message 54-2).

More particularly, in response to determining that the UE 36-2 is authorized to access the service provider network 12, the AAA server 66 may determine an identity of the particular network subscriber 100-2 associated with the UE 36-2 based on the access identity information 56-2 (e.g., network credentials 58-2, subscriber information 60-2, device information 62-2). In some examples, the AAA server 66 may determine that the subscriber policy data 70-2 associated with the UE 36-2 is stored in the memory 68 (e.g., data cache) based on the identity of the particular network subscriber 100-2. In such examples, the AAA server 66 may obtain the subscriber policy data 70-2 associated with the UE 36-2 from the memory 68.

In some examples, the AAA server 66 may obtain the subscriber policy data 70-2 associated with the UE 36-2 from a remote computing device, such as the subscriber database 72. The AAA server 66 may query the subscriber database 72 based on the identity of the particular network subscriber 100-2 associated with the UE 36-2. For instance, the AAA server 66 may determine that a particular subscriber profile 74-2 in the subscriber database 72 is associated with the particular network subscriber 100-2. The AAA server 66 may obtain the subscriber policy data 70-2 of the particular subscriber profile 74-2 in the subscriber database 72 that is associated with the particular network subscriber 100-2 from the subscriber database 72. In some examples, subsequent to obtaining the subscriber policy data 70-2 of the particular subscriber profile 74-2 that is associated with the particular network subscriber 100-2, the AAA server 66 may store the subscriber policy data 70-2 in the memory 68 (e.g., data cache) for a predetermined time period (e.g., 1 minute, 1 hour, 1 day, 1 week, etc.).

The computing system 16 may then select one of the plurality of different core gateways 18 implemented by the computing system 16 based on the subscriber policy data 70 associated with the UE 36. More particularly, continuing the example described above, subsequent to obtaining the subscriber policy data 70-2 associated with the UE 36-2, the computing system 16 (e.g., the AAA server 66) may determine that the UE 36-2 is associated with a different service tier 78 relative to the UE 36-1, such as the second service tier 78-2 of the plurality of different service tiers 78, based on the subscriber policy data 70-2.

The computing system 16 (e.g., AAA server 66) may determine that a different core gateway 18, such as the core gateway 18-2, is operable to provide the network services associated with the second service tier 78-2 and, in response, may select the core gateway 18-2 to provide default gateway functionality to the UE 36-2. More particularly, the AAA server 66 may determine that the core gateway 18-2 includes sufficient network resources (e.g., queues, memory, etc.) to provide the network services associated with the second service tier 78-2 and, as such, may determine that the core gateway 18-2 is suitable to provide default gateway functionality to the UE 36-2.

The computing system 16 may generate and send an access-accept message 80-2 to the wireless AP 28-1 that indicates the UE 36-2 is authorized to access the service provider network 12. More particularly, in some examples, in response to selecting the core gateway 18-2 of the plurality of different core gateways 18, the computing system 16 (e.g., AAA server 66) may generate routing instructions 82-2 configured to cause the wireless AP 28-1 to establish the layer 2 tunnel 44-2 (e.g., GRE tunnel) with the core gateway 18-2, thereby facilitating use of the core gateway 18-2 by the UE 36-2. As shown, the layer 2 tunnel 44-2 may be a different layer 2 tunnel 44 relative to the layer 2 tunnel 44-1. The routing instructions 82-2 may be similar to the routing instructions 82-1 described above. For instance, the routing instructions 82-2 may include a second core gateway identifier 84-2 identifying the core gateway 18-2 as a tunnel endpoint 44-2′ for the layer 2 tunnel 44-2. By way of non-limiting illustrative example, the second core gateway identifier 84-2 may include an Internet Protocol address associated with the core gateway 18-2, a Uniform Resource Locator (URL) address associated with the core gateway 18-2, and/or the like.

The wireless AP 28-1 may receive the access-accept message 80-2 from the computing system 16 and may establish the layer 2 tunnel 44-2 based on the routing instructions 82-2. Subsequently, the UE 36-2 may proceed with the initialization process with the service provider network 12 (e.g., via wireless AP 28-1) and, once completed, may begin exchanging data with and/or over the service provider network 12. For instance, the UE 36-2 may provide a message 88-2 to the wireless AP 28-1, which encapsulates the message 88-2 into a layer 3 protocol and provides the message 88-2 to the core gateway 18-2 via the layer 2 tunnel 44-2 for transmission to entities operating on other networks. Likewise, the core gateway 18-2 may receive data 90-2 addressed to the UE 36-2 and may provide the data 90-2 to the UE 36-2 via the layer 2 tunnel 44-2. In this manner, the wireless AP 28-1 may be operable to facilitate layer 2 (over layer 3) communications for different UEs 36 operating on the same LAN 14-1 with different core gateways 18 of the computing system 16.

Although described above in the context of two UEs 36 operating on the same LAN 14-1, the computing system 16 may be operable to dynamically assign core gateways 18 to any number of UEs 36 operating on the same LAN 14-1, on different LANs 14-1-14-N, and/or any combination thereof. Moreover, although described as dynamically assigning core gateways 18 in the service provider network 12, the computing system 16 may determine that a core gateway (not shown) on a different service provider network (not shown) should provide default gateway functionality to a UE 36 based on the corresponding subscriber policy data 70. That is, the computing system 16 may determine that a UE 36 is associated with a different service provider (not shown) and, in such examples, may select a core gateway (not shown) implemented by a different service provider network (not shown) and/or service provider (not shown).

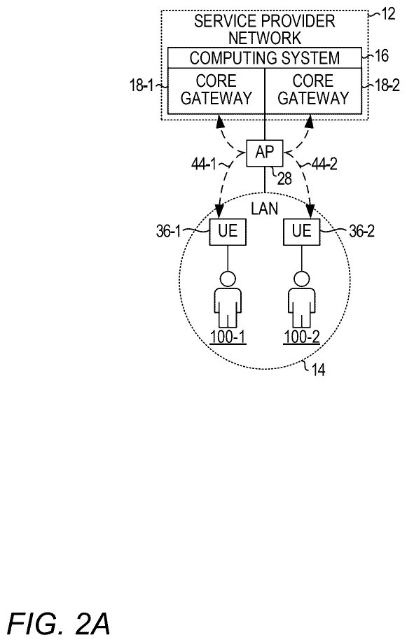

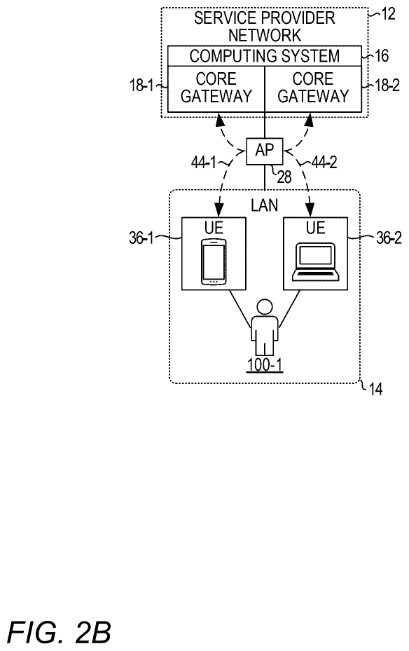

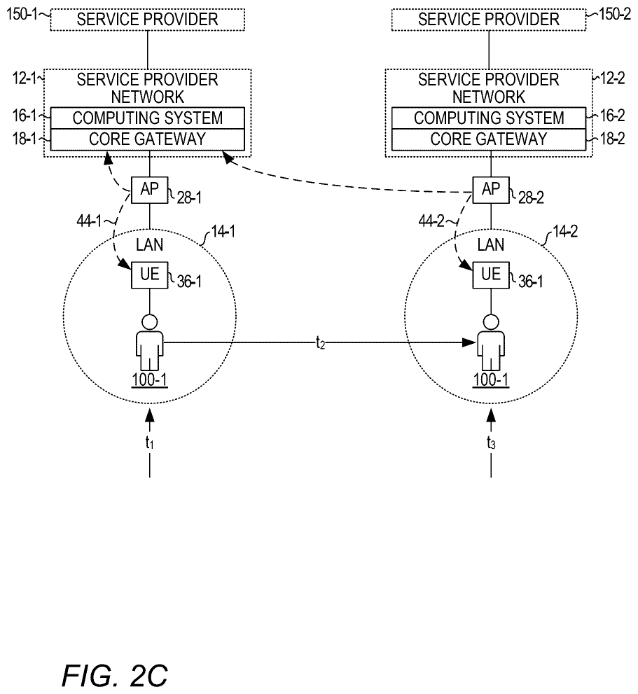

FIGS. 2A-2C depict non-limiting illustrative examples of the dynamic core gateway assignment operations described herein according to some implementations. FIGS. 2A-2C will be discussed in conjunction with FIG. 1.

Referring now to FIG. 2A, a first UE 36-1 (e.g., associated with a first network subscriber 100-1) and a second UE 36-2 (e.g., associated with a second network subscriber 100-2) are connected to a wireless AP 28 that is coupled to a LAN 14. In this example, the first network subscriber 100-1 has a network subscription associated with a premium service tier (e.g., first service tier 78-1), and the second network subscriber 100-2 has a network subscription associated with a basic service tier (e.g., second service tier 78-2). Although connected to the same LAN 14, the computing system 16 may provide differentiated services to the first UE 36-1 and the second UE 36-2 by instructing the wireless AP 28 to route network traffic from the UEs 36-1-36-2 to different core gateways 18-1 18-2. More particularly, in this example, the first core gateway 18-1 is operable to provide network services associated with the first service tier 78-1, and the second core gateway 18-2 is operable to provide network services associated with the second service tier 78-2. As such, the computing system 16 generates routing instructions 82-1 that cause the wireless AP 28 to establish a layer 2 tunnel 44-1 with the first core gateway 18-1, which provides layer 2 adjacency between the first UE 36-1 and the first core gateway 18-1. The computing system 16 also generates routing instructions 82-2 that cause the wireless AP 28 to establish a layer 2 tunnel 44-2 with the second core gateway 18-2, which provides layer 2 adjacency between the second UE 36-2 and the second core gateway 18-2. In this way, the first UE 36-1 is able to receive premium network services (e.g., associated with the first service tier 78-1), and the second UE 36-2 is able to receive basic network services (e.g., associated with the second service tier 78-2), while operating on the same LAN 14 and via the same wireless AP 28.

Referring now to FIG. 2B, a first UE 36-1 and a second UE 36-2 are connected to a wireless AP 28 that is coupled to a LAN 14. In this example, the first UE 36-1 is a computing device operable as a mobile client (e.g., smartphone), and the second UE 36-2 is a computing device operable as a broadband client. (e.g., laptop). Additionally, a first core gateway 18-1 is operable to provide network services associated with mobile clients (e.g., wireless access gateway (WAG)), and a second core gateway 18-2 is operable to provide network services associated with broadband clients (e.g., broadband network gateway (BNG)). As such, the computing system 16 generates routing instructions 82-1 that cause the wireless AP 28 to establish a layer 2 tunnel 44-1 with the first core gateway 18-1, which provides layer 2 adjacency between the first UE 36-1 and the first core gateway 18-1. The computing system 16 also generates routing instructions 82-2 that cause the wireless AP 28 to establish a layer 2 tunnel 44-2 with the second core gateway 18-2, which provides layer 2 adjacency between the second UE 36-2 and the second core gateway 18-2. In this way, the first UE 36-1 is able to receive mobile client-based network services, and the second UE 36-2 is able to receive broadband client-based network services.

Referring now to FIG. 2C, a network subscriber 100-1 associated with a UE 36-1 has a network subscription associated with a first service provider 150-1. The first service provider 150-1 is associated with a first service provider network 12-1, which provides broadband access to entities operating on a first LAN 14-1. Additionally, the first service provider 150-1 is in a network partnership agreement (e.g., roaming agreement) with a second service provider 150-2. The second service provider 150-2 is associated with a second service provider network 12-2, which provides broadband access to entities operating on a second LAN 14-2.

As shown, at time t1, the UE 36-1 is connected to the first LAN 14-1 and, as such, is facilitating use of a first core gateway 18-1 implemented by the first service provider 150-1. At time t2, the UE 36-1 travels to a different location and connects to the second LAN 14-2. At time t3, the UE 36-1 is connected to the second LAN 14-2. However, as noted above, the second service provider 150-2 (e.g., associated with the second service provider network 12-2) is in a network partnership agreement (e.g., roaming agreement) with the first service provider 150-1 (e.g., associated with the first service provider network 12-1). As such, a wireless AP 28-2 coupled to the second LAN 14-2 facilitates use of the first core gateway 18-1 (e.g., implemented by the first service provider 150-1) by the first UE 26-1.

It should be understood that FIGS. 2A-2C are for illustration and discussion and are not intended to be limiting. Those having ordinary skill in the art, using the disclosures provided herein, will understand that the dynamic core-gateway assignment operations described herein may be implemented in any suitable environment for any suitable number of UEs and any suitable number of service providers.

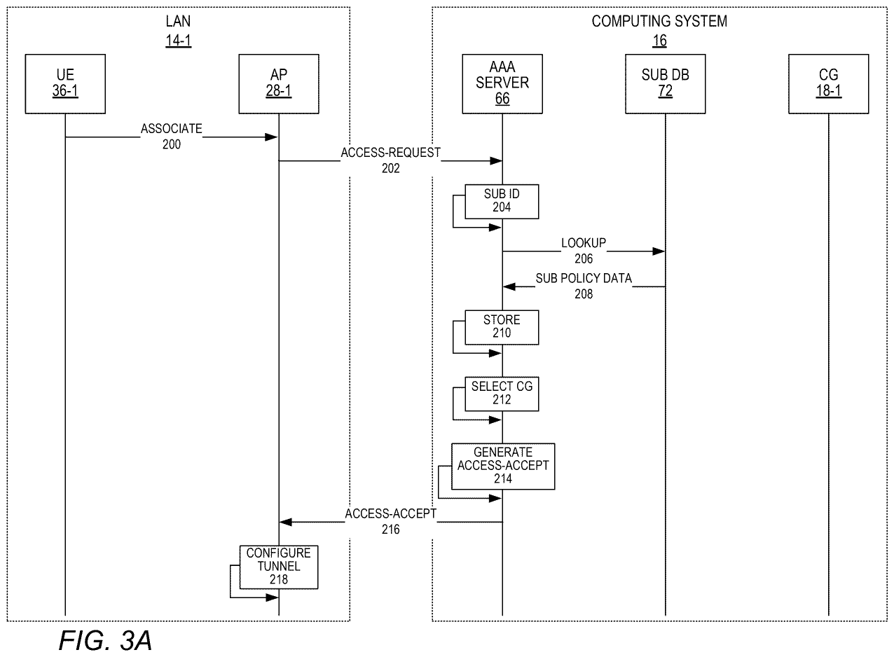

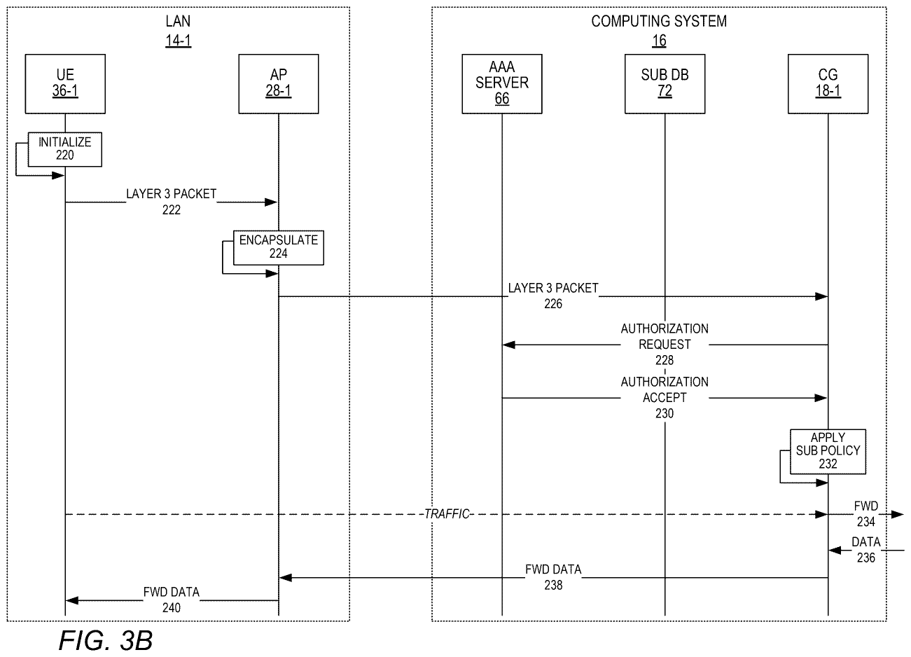

FIGS. 3A-3B are sequence diagrams illustrating messages communicated between and actions taken by certain components illustrated in FIG. 1 to perform dynamic core gateway configuration operations according to some implementations of the present disclosure. FIGS. 3A-3B will be discussed in conjunction with FIG. 1.

Referring to FIG. 3A, the UE 36-1 initiates an association transaction with the wireless AP 28-1 and sends a connection request 52-1 to the wireless AP 28-1. (FIG. 3A, step 200). The wireless AP 28-1 generates an access-request message 54-1, which includes access identity information 56-1, and provides the access-request message 54-1 to the computing system 16, such as to the AAA server 66 (FIG. 3A, step 202). The AAA server 66 identifies a particular network subscriber 100-1 associated with the UE 36-1 (FIG. 3A, step 204) and queries the subscriber database 72 based on the identity of the particular network subscriber 100-1 (FIG. 3A, step 206). The AAA server 66 determines that a particular subscriber profile 74-1 of the plurality of subscriber profiles 74 in the subscriber database 72 is associated with the particular network subscriber 100-1 and, in response, obtains the subscriber policy data 70-1 of the particular subscriber profile 74 that is associated with the particular network subscriber 100-1 from the subscriber database 72 (FIG. 3A, step 208). The AAA server 66 stores the subscriber policy data 70-1 in the memory device 68 (FIG. 3A, step 210).

Subsequent to obtaining the subscriber policy data 70-1 associated with the UE 36-1, the AAA server 66 determines that the core gateway 18-1 is operable to provide network services associated with a particular service tier 78 subscribed to, paid for, etc., by the particular network subscriber 100-1 of the UE 36-1 and, thus, selects the core gateway 18-1 to provide default gateway functionality to the UE 36-1 (FIG. 3A, step 212). The AAA server 66 generates an access-accept message 80-1 that includes routing instructions 82-1, which are configured to cause the wireless AP 28-1 to establish a layer 2 tunnel 44-1 with the core gateway 18-1 (e.g., based on the first core gateway identifier 84-1 identifying the core gateway 18-1 as a tunnel endpoint 44′ for the layer 2 tunnel 44-1) (FIG. 3A, step 214). The AAA server 66 sends the access-accept message 80-1 to the wireless AP 28-1 (FIG. 3A, step 216). The wireless AP 28-1 receives the access-accept message 80-1 from the AAA server 66 and establishes the layer 2 tunnel 44-1 based on the routing instructions 82-1 (FIG. 3A, step 218).

Referring to FIG. 3B, the UE 36-1 proceeds with the initialization process with the service provider network 12 (e.g., via wireless AP 28-1) (FIG. 3B, step 220). The UE 36-1 provides a layer 3 packet (e.g., first message 88-1) to the wireless AP 28-1 (FIG. 3B, step 222). The wireless AP 28-1 encapsulates the layer 3 packet (FIG. 3B, step 224) and provides the layer 3 packet to the core gateway 18-1 (FIG. 3B, step 226). The core gateway 18-1 receives the layer 3 packet from the wireless AP 28-1 and, in response, initiates an authentication operation with the AAA server 66 (FIG. 3B, step 228). The AAA server 66 provides authorization to the core gateway 18-1 (FIG. 3B, step 230), and the core gateway 18-1 is configured to apply the subscriber policy associated with the first UE 36-1 (e.g., based on the subscriber policy data 70-1) (FIG. 3B, step 232). Once configured, the core gateway 18-1 begins forwarding network traffic (e.g., first message(s) 88-1) from the UE 36-1 to upstream computing device(s) (FIG. 3B, step 234). The core gateway 18-1 receives data 90-1 addressed to the UE 36-1 (FIG. 3B, step 236) and provides the data 90-1 to the wireless AP 28-1 (FIG. 3B, step 238), which subsequently forwards the data 90-1 to the UE 36-1 (FIG. 3B, step 240).

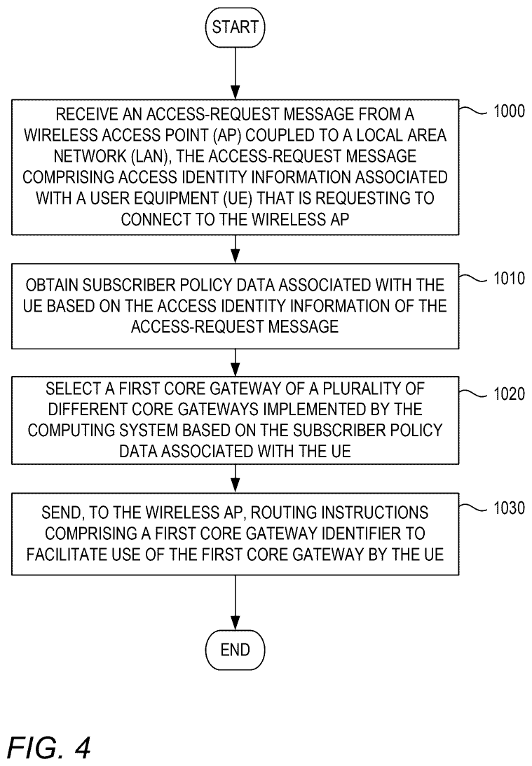

FIG. 4 depicts a flowchart of an example method for implementing dynamic core gateway configuration operations according to some implementations. FIG. 4 will be discussed in conjunction with FIG. 1. The computing system 16 receives an access-request message 54 from a wireless access point (AP) 28 coupled to a local area network (LAN) 14 (FIG. 4, block 1000). The access-request message 54 includes access identity information 56 associated with a user equipment (UE) 36 that is requesting to connect to the wireless AP 28. The computing system 16 obtains subscriber policy data 70 associated with the UE 36 based on the access identity information 56 of the access-request message 54 (FIG. 4, block 1010). The computing system 16 selects a first core gateway 18-1 of a plurality of different core gateways 18 implemented by the computing system 16 based on the subscriber policy data 70 associated with the UE 36 (FIG. 4, block 1020). The computing system 16 sends, to the wireless AP 28, routing instructions 82 including a core gateway identifier 84 (e.g., first core gateway identifier 84-1) to facilitate use of the first core gateway 18-1 by the UE 36 (FIG. 4, block 1030).

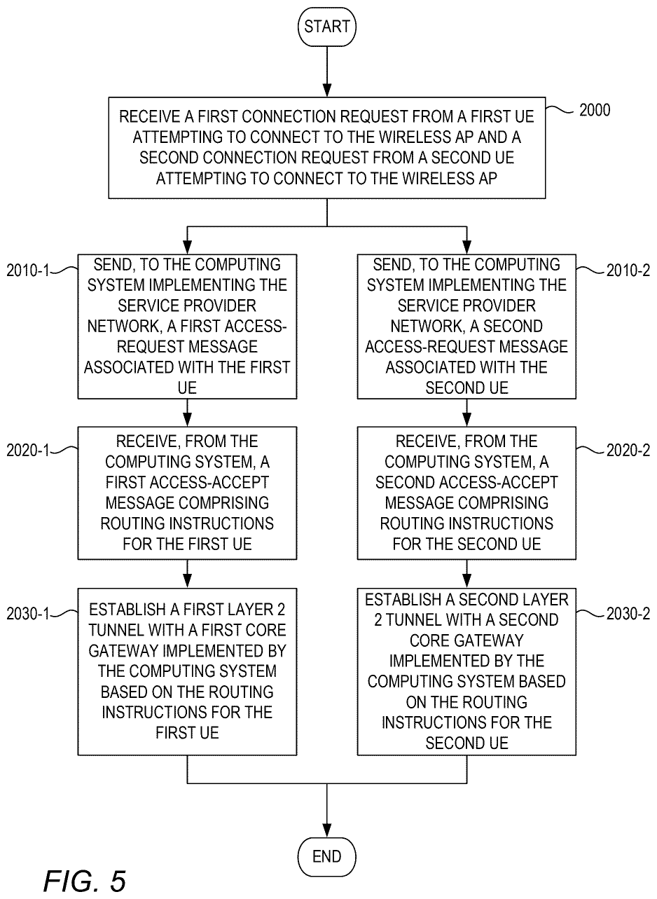

FIG. 5 depicts a flowchart of an example method for implementing dynamic core gateway configuration operations according to some implementations. FIG. 5 will be discussed in conjunction with FIG. 1. A wireless access point (AP) 28-1 coupled to a local area network (LAN) 14-1 receives a first connection request 52-1 from a first user equipment (UE) 36-1 attempting to connect to the wireless AP 28-1 and a second connection request 52-2 from a second user equipment (UE) 36-2 attempting to connect to the wireless AP 28-1 (FIG. 5, block 2000). The wireless AP 28-1 sends, to a computing system 16 implementing a service provider network 12, a first access-request message 54-1 associated with the first UE 36-1 (FIG. 5, block 2010-1) and a second-request message 54-2 associated with the second UE 36-2 (FIG. 5, block 2010-2). The wireless AP 28-1 receives, from the computing system 16, a first access-accept message 80-1 having routing instructions 82-1 for the first UE 36-1 (FIG. 5, block 2020-1) and a second access-accept message 80-2 having routing instructions 82-2 for the second UE 36-2 (FIG. 5, block 2020-2). The wireless AP 28-1 establishes a first layer 2 tunnel 44-1 with a first core gateway 18-1 of a plurality of different core gateways 18 implemented by the computing system 16 (e.g., based on the routing instructions 82-1 for the first UE 36-1) (FIG. 5, block 2030-1) and a second layer 2 tunnel 44-2 with a second core gateway 18-2 of the plurality of different core gateways 18 implemented by the computing system 16 (e.g., based on the routing instructions 82-2 for the second UE 36-2) (FIG. 5, block 2030-2).

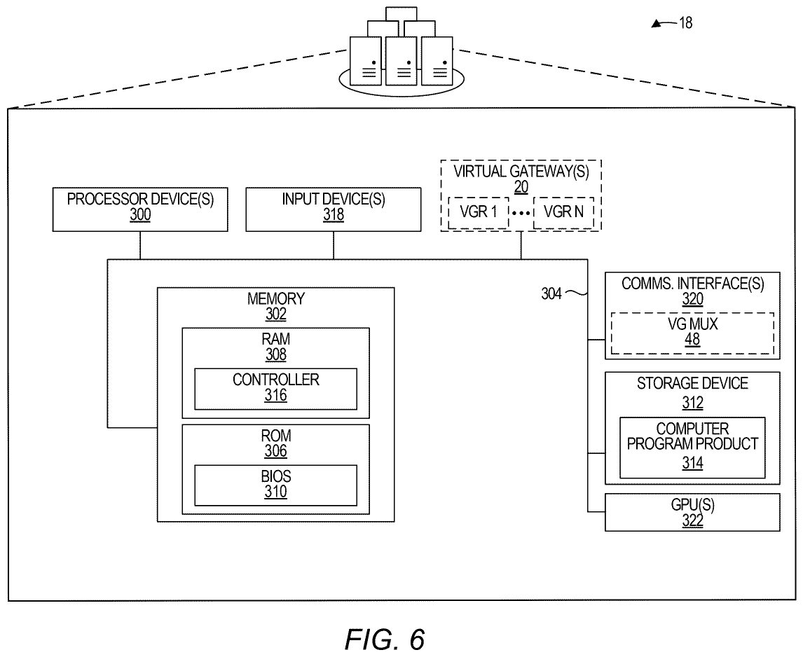

FIG. 6 depicts a block diagram of an example core gateway of the computing system 16 (e.g., described above with reference to FIGS. 1-5), such as a core gateway 18, suitable for implementing the examples disclosed herein according to some implementations. The core gateway 18 may be any suitable computing device configured to initiate a plurality of virtual gateway routers (VGRs), such as the plurality of VGRs 20-1-20-N, that provide default gateway router functions for a local area network (LAN), such as LANs 14-1-14-N.

The core gateway 18 may include any computing and/or electronic device capable of including firmware, hardware, and/or executing software instructions to implement the functionality described herein, such as a computer server, computing device, and/or the like. The core gateway 18 includes processor device(s) 300, a system memory (e.g., memory 302), and a system bus 304. The system bus 304 provides an interface for system components including, but not limited to, the plurality of VGRs 20-1-20-N, the memory 302, and the processor device 300. The processor device(s) 300 may be any commercially available or proprietary processor.

The system bus 304 may be any of several types of bus structures that may further interconnect to a memory bus (with or without a memory controller), a peripheral bus, and/or a local bus using any of a variety of commercially available bus architectures. The memory 302 may include non-volatile memory 306 (e.g., read-only memory (ROM), erasable programmable read-only memory (EPROM), electrically erasable programmable read-only memory (EEPROM), etc.), and volatile memory 308 (e.g., random-access memory (RAM)). A basic input/output system (BIOS) 310 may be stored in the non-volatile memory 306 and may include the basic routines that help to transfer information between elements within the core gateway 18. The volatile memory 308 may also include a high-speed RAM, such as static RAM, for caching data.

The core gateway 18 may further include or be coupled to a non-transitory computer-readable storage medium, such as a storage device 312, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 312 and other drives associated with computer-readable media and computer-usable media may provide non-volatile storage of data, data structures, computer-executable instructions, and the like.

A number of modules can be stored in the storage device 312 and in the volatile memory 308, including an operating system and one or more program modules, which may implement the functionality described herein in whole or in part. All or a portion of the examples may be implemented as a computer program product 314 stored on a transitory or non-transitory computer-usable or computer-readable storage medium, such as the storage device 312, which includes complex programming instructions, such as complex computer-readable program code, to cause the processor device 300 to carry out the steps described herein. Thus, the computer-readable program code may comprise software instructions for implementing the functionality of the examples described herein when executed on the processor device 300. The processor device 300, in conjunction with a controller 316 in the volatile memory 308, may serve as a controller and/or or a control system for the core gateway 18 and/or the computing system 16 that is to implement the functionality described herein.

An operator (e.g., user) may also be able to enter one or more configuration commands through one or more input device(s) 318, such as a keyboard (not illustrated), a pointing device such as a mouse (not illustrated), or a touch-sensitive surface such as a display device. Such input devices 318 may be connected to the processor device 300 through an input interface (not shown) coupled to the system bus 304 but can be connected through other interfaces such as a parallel port, an Institute of Electrical and Electronic Engineers (IEEE) 1394 serial port, a Universal Serial Bus (USB) port, an IR interface, and/or the like.

The core gateway 18 may also include a number of communication interfaces, such as communication interface 320, that are suitable for communicating with a network (or devices connected thereto) as appropriate or desired. For instance, in some examples, the core gateway 18 may be operable to communicate with one or more downstream computing devices (e.g., UEs 36) and/or one or more upstream computing devices (e.g., computing devices coupled to other service provider networks, subscriber database 72, etc.) via the communication interface 320 (e.g., via the virtual gateway multiplexer 48). The core gateway 18 may further include one or more GPUs 322.

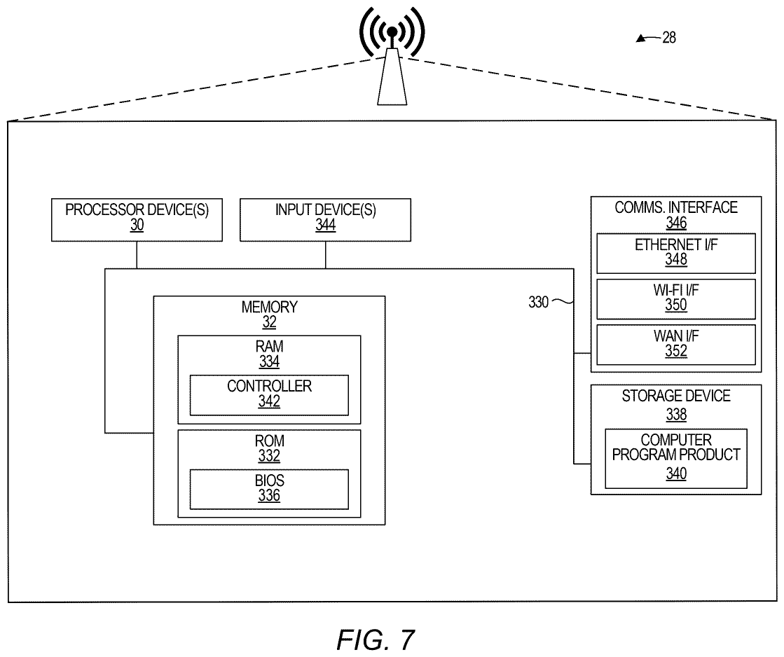

FIG. 7 depicts a block diagram of an example customer premises equipment (CPE) (e.g., described above with reference to FIGS. 1-6), such as a wireless AP 28, suitable for implementing the example disclosed herein according to some implementations. The wireless AP 28 may be any suitable computing device configure to operable as a learning bridge and a Wi-Fi® access point and/or Ethernet switch for a local area network (LAN), such as LANs 14-1-14-N.

The wireless AP 28 may include any computing and/or electronic device capable of including firmware, hardware, and/or executing software instructions to implement the functionality described herein, such as a computer server, computing device, and/or the like. The wireless AP 28 includes processor device(s) 30, a system memory (e.g., memory 32), and a system bus 330. The system bus 330 provides an interface for system components including, but not limited to, the memory 32 and the processor device 30. The processor device(s) 30 may be any commercially available or proprietary processor.

The system bus 330 may be any of several types of bus structures that may further interconnect to a memory bus (with or without a memory controller), a peripheral bus, and/or a local bus using any of a variety of commercially available bus architectures. The memory 32 may include non-volatile memory 332 (e.g., read-only memory (ROM), erasable programmable read-only memory (EPROM), electrically erasable programmable read-only memory (EEPROM), etc.), and volatile memory 334 (e.g., random-access memory (RAM)). A basic input/output system (BIOS) 336 may be stored in the non-volatile memory 332 and may include the basic routines that help to transfer information between elements within the wireless AP 28. The volatile memory 334 may also include a high-speed RAM, such as static RAM, for caching data.

The wireless AP 28 may further include or be coupled to a non-transitory computer-readable storage medium, such as a storage device 338, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 338 and other drives associated with computer-readable media and computer-usable media may provide non-volatile storage of data, data structures, computer-executable instructions, and the like.

A number of modules can be stored in the storage device 338 and in the volatile memory 334, including an operating system and one or more program modules, which may implement the functionality described herein in whole or in part. All or a portion of the examples may be implemented as a computer program product 340 stored on a transitory or non-transitory computer-usable or computer-readable storage medium, such as the storage device 338, which includes complex programming instructions, such as complex computer-readable program code, to cause the processor device 30 to carry out the steps described herein. Thus, the computer-readable program code may comprise software instructions for implementing the functionality of the examples described herein when executed on the processor device 30. The processor device 30, in conjunction with a controller 342 (e.g., controller 34) in the volatile memory 334, may serve as a controller and/or or a control system for the wireless AP 28 and/or the corresponding LAN 14 that is to implement the functionality described herein.

An operator (e.g., user) may also be able to enter one or more configuration commands through one or more input device(s) 344, such as a keyboard (not illustrated), a pointing device such as a mouse (not illustrated), or a touch-sensitive surface such as a display device. Such input devices 344 may be connected to the processor device 30 through an input interface (not shown) coupled to the system bus 330 but can be connected through other interfaces such as a parallel port, an Institute of Electrical and Electronic Engineers (IEEE) 1394 serial port, a Universal Serial Bus (USB) port, an IR interface, and/or the like.

The wireless AP 28 may also include a number of communication interfaces 346 that are suitable for communicating with a network (or devices connected thereto) as appropriate or desired. For instance, in some examples, the wireless AP 28 may include one or more Ethernet communication interfaces 348 to which a computing device (e.g., UEs 36) may be connected via an appropriate cable. Additionally and/or alternatively, in some examples, the wireless AP 28 may serve as a Wi-Fi® access point and, as such, may include one or more Wi-Fi communication interfaces 350 via which computing devices (e.g., UEs 36) may connect to the wireless AP 28 wirelessly. Additionally and/or alternatively, in some examples, the wireless AP 28 may include one or more wide-area network (WAN) interfaces 352 via which the wireless AP 28 may communicate with an upstream computing device associated with the computing system 16 (e.g., service provider network 12) and which facilitates communications with, e.g., one or more core gateways 18-1-18-N.

Other computer system designs and configurations may also be suitable to implement the systems and methods described herein. The following examples illustrate various additional implementations in accordance with one or more aspects of the disclosure.

Example 1 is a non-transitory computer-readable storage medium that includes executable instructions configured to cause a processor device of a computing system to: receive an access-request message from a wireless access point (AP) coupled to a local area network (LAN), the access-request message comprising access identity information associated with a user equipment (UE) that is requesting to connect to the wireless AP; obtain subscriber policy data associated with the UE based on the access identity information of the access-request message; select a first core gateway of a plurality of different core gateways implemented by the computing system based on the subscriber policy data associated with the UE; and send, to the wireless AP, routing instructions comprising a first core gateway identifier to facilitate use of the first core gateway by the UE.

Example 2 is a wireless access point (AP) that is coupled to a local area network (LAN). The wireless AP comprises one or more processor devices that are operable to: receive a first connection request from a first user equipment (UE) attempting to connect to the wireless AP; send, to a computing system implementing a service provider network, a first access-request message associated with the first UE; receive, from the computing system, a first access-accept message comprising routing instructions for the first UE; establish a first layer 2 tunnel with a first core gateway of a plurality of different core gateways implemented by the computing system based on the routing instructions for the first UE; receive a second connection request from a second UE attempting to connect to the wireless AP, the second UE being different from the first UE; send, to the computing system, a second access-request message associated with the second UE; receive, from the computing system, a second access-accept message comprising routing instructions for the second UE; and establish a second layer 2 tunnel with a second core gateway of the plurality of different core gateways implemented by the computing system based on the routing instructions for the second UE.

Example 3 is a non-transitory computer-readable storage medium that includes executable instructions configured to cause a processor device of a wireless access point (AP) to: receive a first connection request from a first user equipment (UE) attempting to connect to the wireless AP; send, to a computing system implementing a service provider network, a first access-request message associated with the first UE; receive, from the computing system, a first access-accept message comprising routing instructions for the first UE; establish a first layer 2 tunnel with a first core gateway of a plurality of different core gateways implemented by the computing system based on the routing instructions for the first UE; receive a second connection request from a second UE attempting to connect to the wireless AP, the second UE being different from the first UE; send, to the computing system, a second access-request message associated with the second UE; receive, from the computing system, a second access-accept message comprising routing instructions for the second UE; and establish a second layer 2 tunnel with a second core gateway of the plurality of different core gateways implemented by the computing system based on the routing instructions for the second UE.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a computing system comprising one or more computing devices, an access-request message from a wireless access point (AP) coupled to a local area network (LAN), the access-request message comprising access identity information associated with a user equipment (UE) that is requesting to connect to the wireless AP;
obtaining, by the computing system, subscriber policy data associated with the UE based on the access identity information of the access-request message;
selecting, by the computing system, a first core gateway of a plurality of different core gateways implemented by the computing system based on the subscriber policy data associated with the UE; and
sending, by the computing system to the wireless AP, routing instructions comprising a first core gateway identifier to facilitate use of the first core gateway by the UE.

2. The method of claim 1, wherein the computing system comprises an Authentication, Authorization, and Accounting (AAA) server, and wherein receiving the access-request message comprises:
receiving, by the AAA server from the wireless AP, the access-request message, the access-request message characterizing a request by the UE to establish a communication link with a service provider network implemented by the computing system via the wireless AP;
processing, by the AAA server, the access-request message to determine whether the UE is authorized to access the service provider network; and
in response to determining that the UE is authorized to access the service provider network, determining, by the AAA server, an identity of a particular network subscriber associated with the UE based on the access identity information of the access-request message.

3. The method of claim 2, wherein the access identity information associated with the UE comprises network credentials provided by the UE to the wireless AP, and wherein determining the identity of the particular network subscriber associated with the UE comprises:
determining, by the AAA server, the identity of the particular network subscriber associated with the UE based on the network credentials provided by the UE to the wireless AP.

4. The method of claim 2, wherein the computing system comprises a subscriber database, the subscriber database comprising a plurality of subscriber profiles associated with a plurality of different network subscribers authorized to access the service provider network, each subscriber profile comprising subscriber policy data respectively associated with one of the plurality of different network subscribers, and wherein obtaining the subscriber policy data associated with the UE comprises:
querying, by the AAA server, the subscriber database based on the identity of the particular network subscriber associated with the UE;
determining, by the AAA server, that a particular subscriber profile of the plurality of subscriber profiles in the subscriber database is associated with the particular network subscriber; and
obtaining, by the AAA server from the subscriber database, the subscriber policy data of the particular subscriber profile that is associated with the particular network subscriber.

5. The method of claim 4, wherein the AAA server comprises a data cache, the method further comprising:
subsequent to obtaining the subscriber policy data of the particular subscriber profile that is associated with the particular network subscriber, storing, by the AAA server, the subscriber policy data of the particular subscriber profile in the data cache for a predetermined time period.

6. The method of claim 2, wherein the AAA server comprises a data cache, and wherein obtaining the subscriber policy data associated with the UE comprises:
determining, by the AAA server, that the subscriber policy data associated with the UE is stored in the data cache based on the identity of the particular network subscriber associated with the UE; and
obtaining, by the AAA server, the subscriber policy data associated with the UE from the data cache.

7. The method of claim 1, wherein selecting the first core gateway of the plurality of different core gateways implemented by the computing system comprises:
subsequent to obtaining the subscriber policy data associated with the UE, determining, by the computing system, that the UE is associated with a first service tier of a plurality of different service tiers based on the subscriber policy data, each of the plurality of different service tiers being associated with different network services relative to one another;
determining, by the computing system, that the first core gateway is operable to provide network services associated with the first service tier; and
in response to determining that the first core gateway is operable to provide the network services associated with the first service tier, selecting, by the computing system, the first core gateway to provide default gateway functionality to the UE.

8. The method of claim 1, wherein sending the routing instructions comprising the first core gateway identifier comprises:
in response to selecting the first core gateway of the plurality of different core gateways, generating, by the computing system, the routing instructions configured to cause the wireless AP to establish a layer 2 tunnel with the first core gateway, the first core gateway identifier identifying the first core gateway as a tunnel endpoint for the layer 2 tunnel; and
sending, by the computing system to the wireless AP, an access-accept message comprising the routing instructions, the access-accept message indicating that the UE is authorized to access a service provider network implemented by the computing system.

9. The method of claim 8, wherein the layer 2 tunnel is a Generic Routing Encapsulation (GRE) tunnel.

10. The method of claim 8, wherein the layer 2 tunnel is configured to provide layer 2 adjacency between the UE and the first core gateway.

11. The method of claim 1, wherein the first core gateway identifier comprises one of an Internet Protocol (IP) address associated with the first core gateway or a Uniform Resource Locator (URL) address associated with the first core gateway.

12. The method of claim 1, wherein the access identity information comprises one or more of:
network credentials provided by the UE to the wireless AP, the network credentials identifying a particular network subscriber associated with the UE as an authorized user of a service provider network implemented by the computing system;
subscriber information characterizing features associated with a particular subscription of the particular network subscriber; and
device information characterizing a device identity and device features associated with the UE.

13. The method of claim 12, wherein the device information comprises a Media Access Control (MAC) address of the UE.

14. The method of claim 1, wherein each core gateway of the plurality of different core gateways is one of a bridged network gateway (BNG) or a wireless access gateway (WAG).

15. The method of claim 1, wherein each core gateway of the plurality of different core gateways implements a plurality of virtual gateway routers (VGRs), each VGR being operable to serve as a default gateway router for the LAN.

16. The method of claim 1, wherein the access-request message is a first access-request message, and wherein the UE is a first UE, the method further comprising:
receiving, by the computing system, a second access-request message from the wireless AP, the second access-request message comprising access identity information associated with a second UE that is requesting to connect to the wireless AP, the second UE being different from the first UE;
obtaining, by the computing system, subscriber policy data associated with the second UE based on the access identity information of the second access-request message;
selecting, by the computing system, a second core gateway of the plurality of different core gateways implemented by the computing system based on the subscriber policy data associated with the second UE, the second core gateway being different from the first core gateway; and
sending, by the computing system to the wireless AP, routing instructions comprising a second core gateway identifier to facilitate use of the second core gateway by the second UE.

17. The method of claim 16, wherein the computing system is configured to facilitate use of the first core gateway by the first UE concurrently with use of the second core gateway by the second UE.

18. A computing system, comprising:
one or more computing devices operable to:
receive an access-request message from a wireless access point (AP) coupled to a local area network (LAN), the access-request message comprising access identity information associated with a user equipment (UE) that is requesting to connect to the wireless AP;
obtain subscriber policy data associated with the UE based on the access identity information of the access-request message;
select a first core gateway of a plurality of different core gateways implemented by the computing system based on the subscriber policy data associated with the UE; and
send, to the wireless AP, routing instructions comprising a first core gateway identifier to facilitate use of the first core gateway by the UE.

19. A method, comprising:
receiving, by a wireless access point (AP) coupled to a local area network (LAN), a first connection request from a first user equipment (UE) attempting to connect to the wireless AP;
sending, by the wireless AP to a computing system implementing a service provider network, a first access-request message associated with the first UE;
receiving, by the wireless AP from the computing system, a first access-accept message comprising routing instructions for the first UE; and
establishing, by the wireless AP, a first layer 2 tunnel with a first core gateway of a plurality of different core gateways implemented by the computing system based on the routing instructions for the first UE.

20. The method of claim 19, further comprising:
receiving, by the wireless AP, a second connection request from a second UE attempting to connect to the wireless AP, the second UE being different from the first UE;
sending, by the wireless AP to the computing system, a second access-request message associated with the second UE;
receiving, by the wireless AP from the computing system, a second access-accept message comprising routing instructions for the second UE;
establishing, by the wireless AP, a second layer 2 tunnel with a second core gateway of the plurality of different core gateways implemented by the computing system based on the routing instructions for the second UE;
concurrently receiving, by the wireless AP, a first message from the first UE and a second message from the second UE;
encapsulating, by the wireless AP, the first message and the second message into a layer 3 protocol;
sending, by the wireless AP to the first core gateway, the first message via the first layer 2 tunnel; and
sending, by the wireless AP to the second core gateway, the second message via the second layer 2 tunnel.
